(19) United States
(12) Patent Application Publication
(10) Pub. No.: US 2010/0166989 A1
(43) Pub. Date: Jul. 1, 2010

(54) Loudspeaker enclosure

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 12/344,511

(22) Filed: Dec. 27, 2008

(51) Int. Cl. B32B 1/00

(52) U.S. Cl. 428/35.6

(57) ABSTRACT

A panel used for constructing loudspeaker enclosure is disclosed which comprises an outer layer formed by a whole sheet of a first board material, the outer layer facing the outside of the loudspeaker enclosure, and an inner layer formed by two or more closely placed pieces of a second board material flatly attached to the outer layer, the inner layer facing the inside of the loudspeaker enclosure, the area of the inner layer being approximately equal to that of the outer layer, the density of the second board material being less than that of the first board material, wherein the inner layer enhances the overall rigidity of the panel, while provides good acoustic damping to the inside of the loudspeaker enclosure.

### BACKGROUND

The present invention relates generally to loudspeakers, and, more particularly, to a loudspeaker enclosure structure.

One goal for better sound reproduction by loudspeakers employing dynamic drivers is to make the loudspeaker enclosure as inert as possible. Therefore, loudspeaker enclosures are typically made of dense materials such as medium-density-fiberboard (MDF) or aluminum. The loudspeaker enclosures are made very thick as well. As a result, some high-end loudspeakers weight as much as 700 pounds each.

Plywood is also traditionally used as loudspeaker enclosing building material. Even though plywood is easy to work with and quite rigid, it tends to have voids which are generally avoided for causing resonations.

Another way to make the loudspeaker enclosure more inert is to dampen the sound inside the loudspeaker enclosure as much as possible. However, dense materials such as MDF or aluminum are very poor damping materials. In order to kills off the unwanted sound inside the loudspeaker enclosures, some are made to have odd shaped or curved enclosures, and are lined with damping materials inside the enclosure. Such solutions make loudspeaker production more complicated and certainly add to the cost.

As such, what is desired is loudspeaker enclosure that has good external inert characteristic yet easy to manufacture.

### SUMMARY

A panel used for constructing loudspeaker enclosure is disclosed which comprises an outer layer formed by a whole sheet of a first board material, the outer layer facing the outside of the loudspeaker enclosure, and an inner layer formed by two or more closely placed pieces of a second board material flatly attached to the outer layer, the inner layer facing the inside of the loudspeaker enclosure, the area of the inner layer being approximately equal to that of the outer layer, the density of the second board material being less than that of the first board material, wherein the inner layer enhances the overall rigidity of the panel, while provides good acoustic damping to the inside of the loudspeaker enclosure.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a perspective view of a typical loudspeaker enclosure.

FIG. 2 is a perspective view of a laminated panel for use in a loudspeaker enclosure structure according to one embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

### DESCRIPTION

The following will provide a detailed description of a loudspeaker enclosure that is constructed by specially laminated panels.

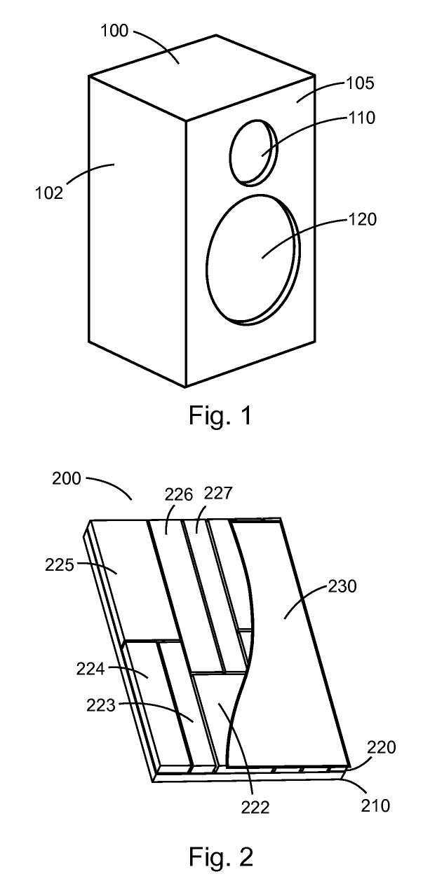

FIG. 1 is a perspective view of a typical loudspeaker enclosure 100. The loudspeaker enclosure 100 is essentially an enclosed box except two driver openings 110 and 120 in the front baffle 105. The opening 110 is typically for mounting a tweeter. The opening 120 is typically for mounting a woofer. In an ideal operating condition, sound should come from the drivers themselves with the enclosure 100 producing little or no sound at all.

FIG. 2 is a perspective view of a laminated panel 200 for use in a loudspeaker enclosure structure according to one embodiment of the present invention. The laminated panel 200 comprises an outer layer 210 and an inner layer 220. The outer layer 210 faces the outside of the loudspeaker enclosure. The inner layer 220 faces the inside of the loudspeaker enclosure. The outer layer 210 is formed by a whole sheet of thick and dense material, such as medium-density-fiberboard (MDF). The inner layer 220 is formed by many small pieces of soft wood planks, 222˜227, of approximately the same thickness attached onto the outer layer 210. Even though the MDF outer layer 210 is much denser than most natural wood, the MDF is less rigid than natural wood. Therefore the wooden inner layer 220 provides rigidity to the laminated panel 200. The soft wood planks 222˜227 may have irregular sizes and are closely placed. They may be joined together and typically sandwiched between two thin sheets of wood for holding the soft wood planks 222˜227 together prior to being attached onto the outer layer 210. FIG. 2 shows a top sheet 230 covering the soft wood planks 222-227. Soft wood forming the inner layer 220 has the benefit of better sound damping. Small planks 222˜227, instead of a whole sheet being used for the inner layer 220 is to alter the resonation frequency of the laminated panel 200. Empirically the laminated panel 200 demonstrates good acoustic inertness. Another reason of using the small wood planks 222˜227 is because the small planks are easier to be attached onto the outer layer 210, as the inner layer 220 need to be of substantial thickness for being effective. Typically both the outer layer 210 and the inner layer 220 should be at least one half inch in thickness. Apparently the laminated panel 200 can be used for constructing all sides of the loudspeaker enclosure 100 of FIG. 1.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A loudspeaker enclosure comprising:
an outer panel formed by a whole sheet of a first board material, the outer panel being on the outside of the loudspeaker enclosure; and
an inner panel having two or more closely placed pieces of a second board material, the entire inner panel being firmly adhered to the outer panel, the inner panel being on the inside of the loudspeaker enclosure, the area of the inner panel being approximately equal to that of the outer panel, the density of the second board material being less than that of the first board material.

2. The panel of claim 1, wherein the first board material is medium-density-fiberboard (MDF).

3. The panel of claim 1, wherein the second board material is natural wood.

4. The panel of claim 3, wherein the second board material is soft natural wood.

5. The panel of claim 1, wherein the two or more closely placed pieces of the second board material are joined together prior to being adhered to the outer panel.

6. The panel of claim 5 further comprising at least one sheet material adhered to the two or more closely placed pieces of the second board material for holding them together.

7. The panel of claim 6, wherein the at least one sheet material is significantly thinner than either the first or the second board material.

8. The panel of claim 6, wherein the at least one sheet material is soft natural wood.

9. A loudspeaker enclosure comprising:
an outer panel formed by a whole sheet of medium-density-fiberboard (MDF) board, the outer panel being on the outside of the loudspeaker enclosure; and
an inner panel having two or more closely placed planks of natural wood, the entire inner panel being firmly adhered to the outer panel, the inner panel being on the inside of the loudspeaker enclosure, the area of the inner panel being approximately equal to that of the outer panel.

10. The panel of claim 9, wherein the planks of natural wood are made of soft wood.

11. The panel of claim 9, wherein the two or more closely placed planks of natural wood are joined together prior to being firmly adhered to the outer panel.

12. The panel of claim 11 further comprising at least one sheet material adhered to the two or more closely placed planks of natural wood for holding them together.

13. The panel of claim 12, wherein the at least one sheet material is significantly thinner than either the MDF board or the natural wood plank.

14. The panel of claim 12, wherein the at least one sheet material is soft natural wood.
